(19) United States
(12) Patent Application Publication
(10) Pub. No.: US 2026/0086364 A1
(43) Pub. Date: Mar. 26, 2026

(54) OPTICAL DEVICE AND WEARABLE DEVICE COMPRISING SAME

(71) Applicant: LG INNOTEK CO., LTD., Seoul (KR)

(72) Inventors: Kang Yeol PARK, Seoul (KR); Bum Jin KIM, Seoul (KR); Yang Hyun JOO, Seoul (KR)

(21) Appl. No.: 19/109,764

(22) PCT Filed: Sep. 7, 2023
(86) PCT No.: PCT/KR2023/013463

§ 371 Date: Mar. 7, 2025

(30) Foreign Application Priority Data
Sep. 7, 2022 (KR) 10-2022-0113805
Sep. 7, 2022 (KR) 10-2022-0113812

(51) Int. Cl. G02B 27/01

(52) U.S. Cl. CPC G02B 27/0172

(57) ABSTRACT

An optical device, according to one embodiment, comprises: a first region for guiding incident light; a second region for emitting the light guided from the first region, wherein the first region comprises a first pattern, the second region comprises a second pattern differing in size or shape from the first pattern, a first virtual straight line which passes a first center of the first region is defined, a second virtual straight line which passes a second center of the second region and is parallel to the first straight line is defined, a third straight line which connects the first center and the second center is defined, a fourth straight line which connects the first straight line and the second straight line is defined, the third straight line is perpendicular to the first straight line and the second straight line, the third straight line is longer than the fourth straight line, and if a line perpendicular to the first straight line at the first center is defined as the X-axis, and the first straight line is defined as the Y-axis, the coordinates of the first center of the first region are (0, 0), and the coordinates of the second center of the second region are (x, y), x being 30 mm to 45 mm, y being −10 mm to 5 mm, and y not including 0.

### TECHNICAL FIELD

An embodiment relates to an optical device and a wearable device including the same.

### BACKGROUND ART

Recent technological advancements have led to various types of wearable devices that can be worn on the body. Among them, augmented reality (AR) devices are wearable devices in the form of glasses that are worn on the user's head. The augmented reality device provides visual information through a display. Thus, a user can receive augmented reality service.

Augmented Reality is the mixing of real-world information with virtual images by inserting 3D images into the real environment.

The real-world information may contain information that the user does not need. Alternatively, the real-world information may lack information that the user needs. However, augmented reality systems combine the real world and the virtual world. Thus, interaction between the real world and the virtual world takes place in real time.

Unlike virtual reality (VR) devices that block the field of vision, the augmented reality (AR) device does not block the field of vision while in use. Further, the augmented reality (AR) device displays a wide screen-level display in front of the eyes while worn like regular glasses. Furthermore, the augmented reality (AR) device can provide expanded reality that combines reality and AR contents using 360° space based on the user. Additionally, the augmented reality (AR) device can provide the user with an optimized display while leaving both hands free.

The augmented reality device includes an optical module. The optical module provides augmented reality images to the user. For example, the augmented reality device may be configured of wearable glasses which are optical devices. In addition, a projector that projects images onto the wearable glasses may be combined.

Light emitted from the projector passes through the optical device and is incident on the user's eyes. Thus, the user sees the augmented reality display.

The light emitted from the projector is diffracted by the optical device and is incident on the user's eyes. Thus, the optical device may include a diffraction pattern. When the size of the diffraction pattern increases, the size of the optical device may increase. Additionally, the diffraction pattern may be visible to the user. Thus, user's visibility may be reduced.

Therefore, an optical device capable of solving the problems is required.

### DISCLOSURE

### Technical Problem

An embodiment is directed to providing an optical device having a small size and a wearable device including the same.

An embodiment is directed to providing an optical device having an improved feeling of wearing and visibility and a wearable device including the same.

### Technical Solution

An optical device according to an embodiment includes a first region configured to guide incident light, and a second region configured to emit the light guided from the first region, wherein the first region includes a first pattern, the second region includes a second pattern which differs in size or shape from the first pattern, a first virtual straight line which passes through a first center of the first region is defined, a second virtual straight line which passes through a second center of the second region and is parallel to the first straight line is defined, a third straight line which connects the first center and the second center is defined, a fourth straight line which connects the first straight line and the second straight line is defined, the third straight line is perpendicular to the first straight line and the second straight line, the third straight line is longer than the fourth straight line, and when a line perpendicular to the first straight line at the first center is defined as an X-axis, and the first straight line is defined as a Y-axis, the coordinates of the first center of the first region are (0, 0), the coordinates of the second center of the second region are (x, y), the x is 30 mm or more and 45 mm or less, the y being-10 mm or more and 5 mm or less, and the y is not 0.

### Advantageous Effects

The size of the optical device according to the embodiment is reduced. In detail, the optical device includes a second diffractive element that diffracts light in two directions. Therefore, no additional diffractive element is required to expand the angle of light.

Since the additional diffractive elements are omitted, the size of the optical device is reduced. In addition, user's visibility is improved.

The incident region and the emission region of the optical device are spaced apart in the X-axis direction. That is, light incident on the incident region moves in the X-axis direction and is emitted to the emission region.

The light source member for emitting light to the optical device is disposed in a region adjacent to the user's temple. Therefore, the user can use the wearable device with a feeling of wearing similar to that of actual glasses.

The centers of the first region which is the incident region and the second region which is the emission region do not coincide with each other in the X-axis direction and the Y-axis direction.

Thus, the second region is disposed below the first region. Therefore, the user can easily see light including image information emitted from the light source member.

An optical device according to an embodiment includes a first diffractive element and a second diffractive element. A pattern of the first diffractive element and a pattern of the second diffractive element are inclined with respect to the X-axis direction.

Thus, the diffraction efficiency of the first diffractive element and the second diffractive element is improved. Therefore, a region in which light is emitted toward the user in the second region can be formed at an optimal position. Therefore, the user's visibility is improved.

### DESCRIPTION OF DRAWINGS

FIG. 1 is a view illustrating a display device including an optical device according to an embodiment.

FIGS. 2 and 3 are top views of a first surface of the optical device according to an embodiment.

FIG. 4 is an enlarged view of a region A of FIG. 2.

FIGS. 5 and 6 are enlarged views of a region B of FIG. 2.

FIGS. 7 and 8 are other top views of the first surface of the optical device according to an embodiment.

FIGS. 9 and 10 are views for describing the arrangement of diffractive elements of the optical device according to an embodiment.

FIGS. 11 and 12 are views for describing an effect when a pattern of the diffractive element of the optical device according to the embodiment has directionality.

FIGS. 13 and 14 are views for describing a period of the diffractive element of the optical device according to an embodiment.

FIG. 15 is a view illustrating a wearable device to which the optical device according to the embodiment is applied.

### MODES OF THE INVENTION

Exemplary embodiments of the present invention will be described in detail below with reference to the accompanying drawings. However, the technical idea of the present invention is not limited to some of the embodiments described, but can be implemented in various different forms, and within the scope of the technical idea of the present invention, one or more of the components among the embodiments may be selectively combined or substituted and used.

In addition, the terms (including technical and scientific terms) used in the embodiments of the present invention may be interpreted as having meanings that are generally understood by a person of ordinary skill in the technical field to which the present invention belongs, unless explicitly and specifically defined and described, and commonly used terms such as terms defined in dictionaries may be interpreted in consideration of their contextual meaning in the related art.

Additionally, the terms used in the embodiments of the present invention are for the purpose of describing the embodiments and are not intended to limit the present invention. In this specification, the singular may also include the plural unless the context clearly dictates otherwise, and when described as “at least one (or one or more) of A, B, and C,” it may include one or more of all possible combinations of A, B, and C.

Additionally, in describing components of embodiments of the present invention, terms such as first, second, A, B, (a), (b), or the like may be used. These terms are only intended to distinguish one component from another, and are not intended to limit the nature, order, or sequence of the component.

In addition, when a component is described as being “connected,” “coupled,” or “linked” to another component, it may include not only cases in which the component is directly connected, coupled, or linked to the other component, but also cases in which the component is “connected,” “coupled,” or “linked” by another component between the component and the other component.

Additionally, when a component is described as being formed or disposed on “on (above) or below (under)” another component, “above” or “below” includes not only cases in which the two components are in direct contact with each other, but also cases in which one or more other components are formed or disposed between the two components.

Additionally, when expressed as “on (above) or below (under),” it can include the meaning of not only the upward direction but also the downward direction based on one component.

Hereinafter, an optical device according to an embodiment will be described with reference to the drawings.

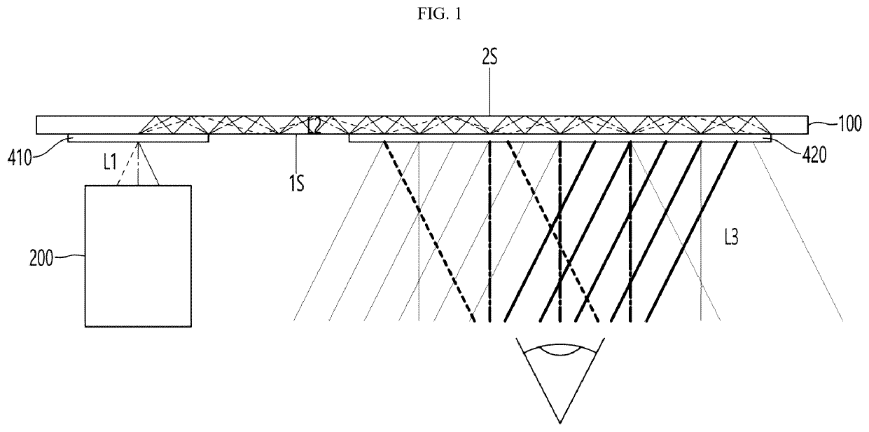

FIG. 1 is a view illustrating a part of a wearable device including an optical device according to an embodiment. The wearable device described below is an augmented reality (AR) device.

Referring to FIG. 1, the wearable device includes an optical device 100, a light source member 200, and diffractive elements 410 and 420.

The optical device 100 has a first surface 1S and a second surface 2S opposite to the first surface 1S.

Light is incident on the first surface 1S. In addition, the light is emitted from the first surface 1S. In detail, light emitted from the light source member 200 is emitted in the direction to the first surface 1S. Thus, the light is incident into the inside of the optical device 100 through the first surface 1S. The light incident into the inside of the optical device 100 is totally reflected inside the optical device 100. In addition, the light is emitted to the outside of the optical device 100 through the first surface 1S. Thus, the emitted light emitted through the first surface 1S is transmitted to a user.

The optical device 100 includes a material that transmits light. The optical device 100 has a refractive index within a set range. In detail, the optical device 100 includes a material having a refractive index of 1.82 or higher. For example, the optical device 100 includes glass having a refractive index of 1.82 to 2.

The optical device 100 may have various shapes. For example, the optical device 100 may have a circular shape or an oval shape including a curved surface. Alternatively, the optical device 100 may have a polygonal shape such as a triangle or a quadrangle.

The optical device 100 guides light. For example, the optical device 100 may be a waveguide.

The light source member 200 may include a projector. Light emitted from the light source member 200 may include image information. That is, the light incident on the optical device 100 includes image information. Therefore, image information emitted from the light source member 200 through the optical device 200 is transmitted to the user.

The optical device 100 includes a plurality of diffractive elements. In detail, the optical device 100 includes a first diffractive element 410 and a second diffractive element 420. The first diffractive element 410 is disposed between the optical device 100 and the light source member 200. In addition, the second diffractive element 420 is disposed between the optical device 100 and a user.

In detail, the first diffractive element 410 is disposed between the optical device 100 and the light source member 200 based on a path of the light. Additionally, the second diffractive element 420 is disposed between the optical device 100 and the user based on the path of the light.

Thus, the light emitted from the light source member 100 passes through the first diffractive element 410 and is incident into the inside of the optical device 100. Additionally, the light emitted from the inside of the optical device 100 passes through the second diffractive element 420 and is transmitted to the user.

Hereinafter, the light that moves in the direction to the first surface 1S from the light source member 200 is defined as first light L1. Additionally, the light that passes through the first diffractive element 410 and is incident into the inside of the optical device 100 is defined as second light L2. Additionally, the light that passes through the second diffractive element 420 and is emitted to the user is defined as third light L3.

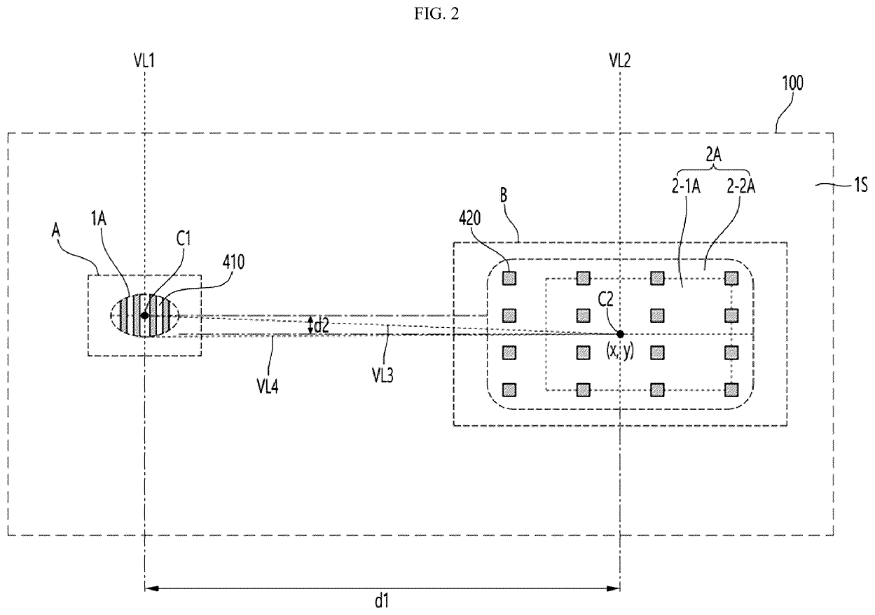

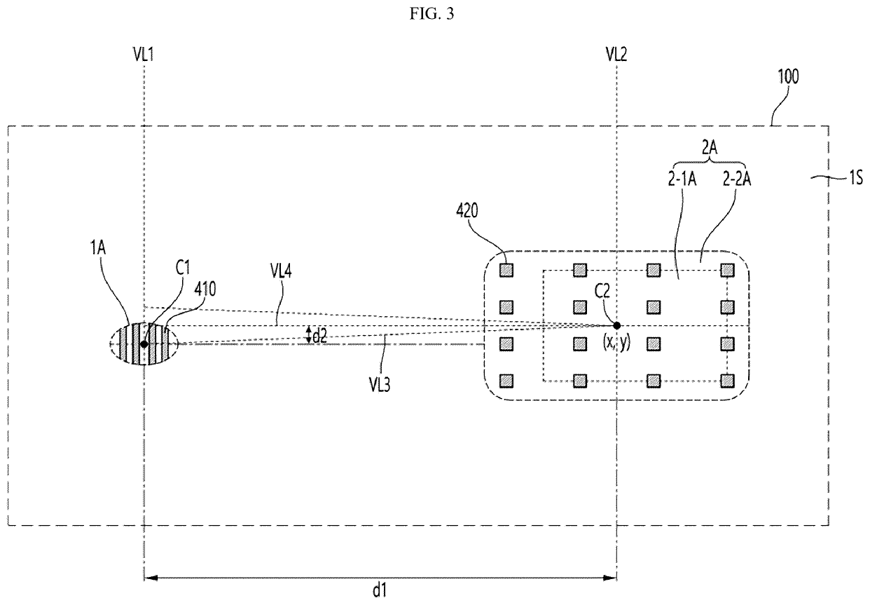

Referring to FIGS. 2 and 3, the optical device 100 includes a plurality of regions. In detail, the first side 1S of the optical device 100 includes a first region 1A and a second region 2A.

The first region 1A is a region in which the first diffractive element 410 is disposed. The second region 2A is a region in which the second diffractive element 420 is disposed.

The first region 1A guides light incident on the optical device 100. In detail, the first region 1A is a region in which light emitted from the light source member 200 is incident. The light emitted from the light source member 200 includes image information. The first region 1A guides the light emitted from the light source member 200. That is, the first region 1A guides the light into the inside of the optical device 100.

Additionally, the light guided in the first region 1A is emitted to the outside of the optical device 100 by the second region 2A.

Thus, the light guided through the first region 1A into the inside of the optical device 100 is emitted to the outside of the optical device 100 through the second region 2A. Therefore, image information is transmitted to the user.

The first light L1 is diffracted in one direction by the first diffractive element 410. As a result, the first light L1 is diffracted to be the second light L2. The second light L2 is guided into the inside of the optical device 100. In addition, the second light L2 is totally reflected inside the optical device 100. The second light L2 is diffracted into the third light L3 by the second diffractive element 420. The second light L2 is diffracted in at least two directions. Thus, the second light L2 is diffracted into the third light L3. That is, the second light L2 is diffracted in two directions by the second diffractive element 420. Therefore, the third light L3 diffracted by the first diffractive element 410 and the second diffractive element 420 is transmitted to the user. Thus, image information is transmitted to the user.

The second region 2A includes a plurality of regions. For example, the second region 2A includes a 2-1 region 2-1A and a 2-2 region 2-2A. The 2-1 region 2-1A is an inner region of the second region 2A. In addition, the 2-2 region 2-2A is an edge region of the second region 2A. That is, the 2-2 region 2-2A surrounds the 2-1 region 2-1A.

The 2-1 region 2-1A is defined as an effective region. That is, the 2-1 region 2-1A is a region in which light is transmitted toward the user. In addition, the 2-2 region 2-2A is defined as an ineffective region. That is, the 2-2 region 2-2A is a region in which light is not transmitted toward the user. That is, light emitted from the 2-2 region 2-2A is not transmitted toward the user.

The 2-1 region 2-1A and the 2-2 region 2-2A are regions in which an angle of the second light L2 expands. In detail, the angle of the second light L2 expands by the second diffractive element 420. Thus, the light emitted from the 2-2 region 2-2A is emitted at an angle exceeding the angle of view of the display device. Therefore, the light emitted from the 2-2 region 2-2A is not transmitted to the user.

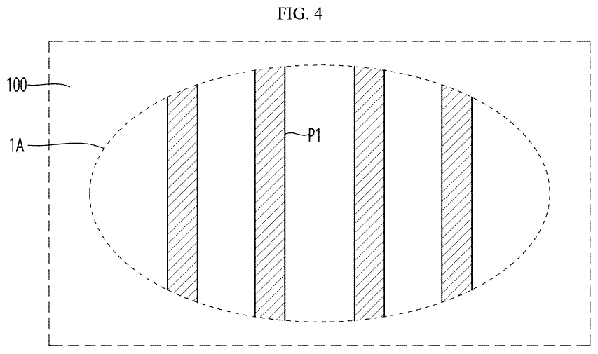

FIG. 4 is an enlarged view of a region A of FIG. 2.

Referring to FIG. 4, the first region 1A includes a first pattern P1. In detail, the first region 1A includes a plurality of first patterns P1. The first diffractive element 410 is configured of the first patterns P1. The first pattern P1 has a set size. For example, the first pattern P1 has an area and thickness within a set range. The first pattern P1 is disposed in a stripe shape. In detail, the first pattern P1 extends in one direction. For example, the first pattern P1 may be a line pattern.

The first light L1 is diffracted in one direction by the first diffractive element 410.

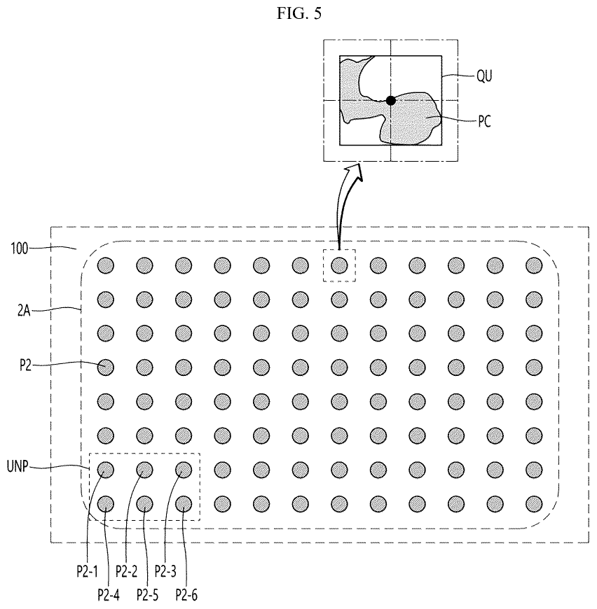

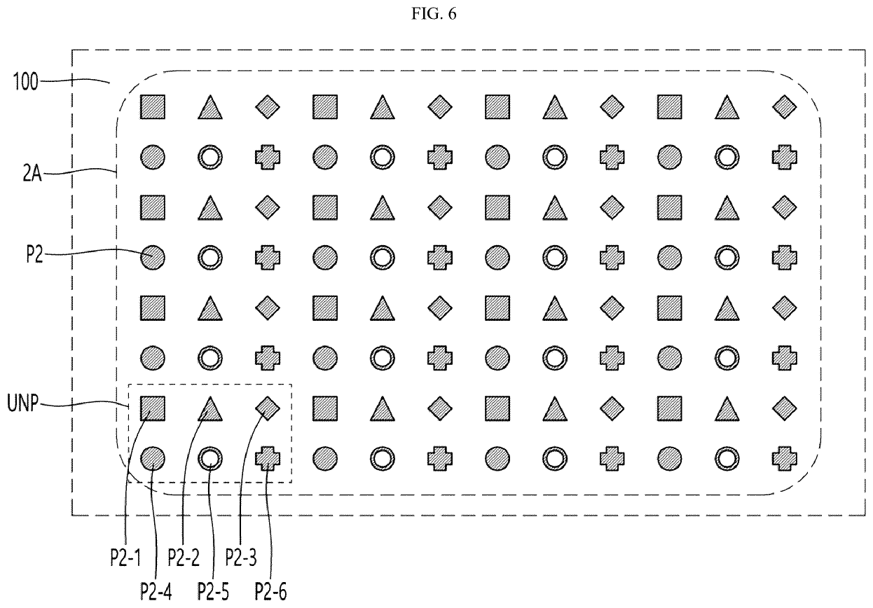

FIGS. 5 and 6 are enlarged views of a region B of FIG. 2.

Referring to FIGS. 5 and 6, the second region 2A includes a second pattern P2. In detail, the second region 2A includes a plurality of second patterns P2. The second diffractive element 420 is configured of the second patterns P2. The second pattern P2 is different from the first pattern P1. In detail, the first pattern P1 and the second pattern P2 have different sizes or shapes. For example, the first pattern P1 and the second pattern P2 may have different heights, shapes, and thicknesses.

The second pattern P2 is formed in a free form shape. The second diffractive element 420 may include a unit pattern UNP. The unit pattern UNP includes a plurality of second patterns P2.

In detail, the second diffractive element 420 includes a plurality of unit patterns UNP. That is, in the second diffractive element 420, the plurality of unit patterns UNP are repeatedly disposed. The unit pattern UNP is formed by N rows (N is a natural number) and M columns (M is a natural number). Thus, the second region 2A includes a second pattern configured of rows and columns of N*M. An interval between centers of the patterns disposed in one of the N rows may be the same as an interval between centers of the patterns disposed in another row. The row may be in a transverse direction and the column may be in a longitudinal direction.

The above-described pattern can be assumed to have a shape of the enlarged view of FIG. 5. When a smallest quadrangle QU that includes all outermost points of the pattern is defined, a pattern center PC can be defined as a center of the quadrangle QU. At this time, the quadrangle may be a square or a rectangle. An interval between the pattern centers may be defined as an interval between the centers of the patterns.

A plurality of patterns are disposed inside the unit pattern UNP. For example, a plurality of patterns having different shapes or sizes are disposed inside the unit pattern UNP. FIGS. 5 and 6 illustrate that the unit pattern UNP is formed by two rows and three columns and includes a 2-1 pattern P2-1, a 2-2 pattern P2-2, a 2-3 pattern P2-3, a 2-4 pattern P2-4, a 2-5 pattern P2-5, and a 2-6 pattern P2-6. However, the embodiment is not limited thereto. The unit pattern may be formed by a combination of various numbers of rows and columns.

The second light L2 is diffracted in a plurality of directions by the second diffractive element 420. The second light L2 is diffracted in a first direction in which the second light expands and in a second direction different from the first direction. In detail, the first direction is a direction in which the second light L2 expands to 60° or 90° by the second diffractive element 420.

The second light L2 is diffracted in a plurality of directions by the second diffractive element 420. Therefore, the number of diffractive elements of the optical device 100 is reduced. Conventionally, a third diffractive element is disposed between the first diffractive element 410 and the second diffractive element 420. Light passing through the first diffractive element, the second diffractive element, and the third diffractive element is diffracted in one direction. However, as the angle of view of the optical device increases, the size of the third diffractive element increases. Thus, the size of the optical device increases. Alternatively, the diffractive element is visible to the user.

However, in the optical device, the problem can be solved because the second diffractive element 420 diffracts light in a plurality of directions.

Referring to FIGS. 2 and 3, in the first region 1A and the second region 2A, a center of each of the regions is defined. For example, in the first region 1A, a first center C1 is defined. In the second region 2A, a second center C2 is defined.

Further, a plurality of virtual straight lines passing through the first center C1 and the second center C2 are defined.

For example, a virtual first straight line VL1 passing through the first center C1 is defined. In addition, a virtual second straight line VL2 passing through the second center C2 and parallel to the first straight line VL1 is defined. Additionally, a virtual third straight line VL3 that connects the first center C1 and the second center C2 is defined. Additionally, a virtual fourth straight line VL4 that is perpendicular to the first straight line VL1 and the second straight line VL2 and connects the first straight line VL1 and the second straight line VL2 is defined. In detail, the fourth straight line VL4 may be a straight line that connects the first straight line VL1 and the second straight line VL2 with a shortest distance.

The third straight line VL3 and the fourth straight line VL4 may have different lengths. In detail, a length of the third straight line VL3 may be longer than a length of the fourth straight line VL4.

A line perpendicular to the first straight line VL1 is defined as an X-axis. In addition, the first straight line VL1 is defined as a Y-axis. Thus, the coordinates of each of the first center C1 and the second center C2 are set.

In detail, first coordinates of the first center C1 are set to (0, 0). Additionally, second coordinates of the second center C2 are set to (x, y).

The x and the y have set sizes. The x may be 30 mm or more to 45 mm or less. Also, the y may be −10 mm or more to 5 mm or less. (y≠0)

Therefore, the first center C1 and the second center C2 are spaced apart from each other by a first interval d1. The first interval d1 in the X-axis direction may be 30 mm to 45 mm.

Additionally, the y has a positive or negative value. That is, the second center C2 is disposed below or above the first center C1 in the Y-axis direction.

Referring to FIG. 2, the second center C2 is disposed below the first center C1 in the Y-axis direction. The y may be between −10 mm to less than 0. Thus, the first center C1 and the second center C2 are spaced apart from each other by a set range in the Y-axis direction. In detail, the first center C1 and the second center C2 are spaced apart from each other by −10 mm to less than 0 mm in the Y-axis direction. Therefore, the first center C1 and the second center C2 are spaced apart from each other by a second interval d2. The second interval d2 in the Y-axis direction may be less than −10 mm to less than 0 mm.

Thus, the second region 2A is disposed below the first region 1A. Therefore, the user can easily see the third light emitted from the second region 2A. Typically, the user who wears AR glasses utilizes a lower portion of the glasses lens more than an upper portion thereof. The light source member 200 may be disposed on the user's temple. That is, when the light source member 200 is disposed on a frame of the AR glasses, the light emitted from the light source member 200 is incident on an upper portion of a glasses lens. The second region from which the light is emitted is disposed below the first region. Therefore, the user can easily see image information transmitted through the optical device.

Referring to FIG. 3, the second center C2 is disposed above the first center C1 in the Y-axis direction. The y may be greater than 0 to less than or equal to 5 mm. Thus, the first center C1 and the second center C2 are spaced apart from each other by a set range in the Y-axis direction. In detail, the first center C1 and the second center C2 are spaced apart from each other by greater than 0 mm to less than or equal to 5 mm in the Y-axis direction. Therefore, the first center C1 and the second center C2 are spaced apart from each other by a second interval d2. The second interval d2 in the Y-axis direction may be greater than 0 mm and less than or equal to 5 mm.

Thus, the second region 2A is disposed above the first region 1A. Therefore, even when the 2-1 region 2-1A from which light is emitted to the user is disposed so as to be significantly biased in the Y-axis direction to a lower portion of the second region 2A, the user can easily see the image information transmitted through the optical device.

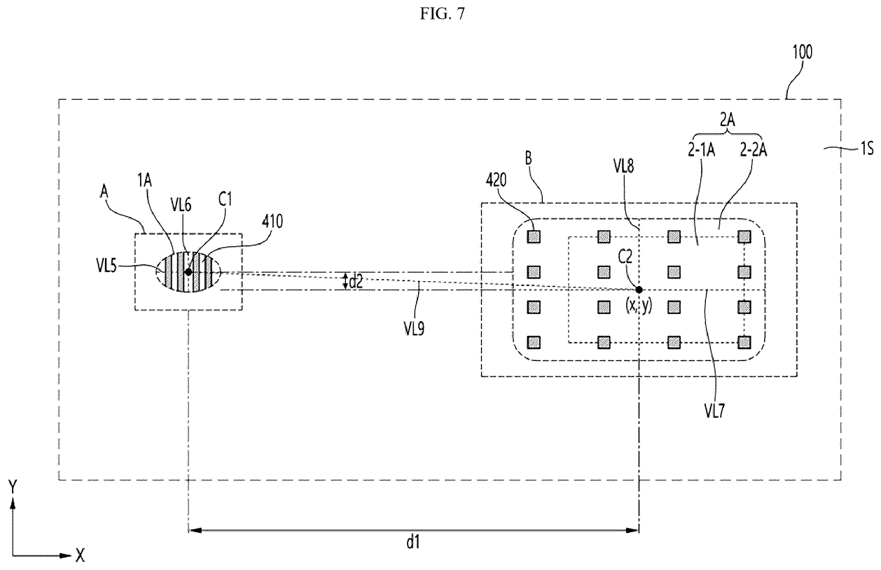

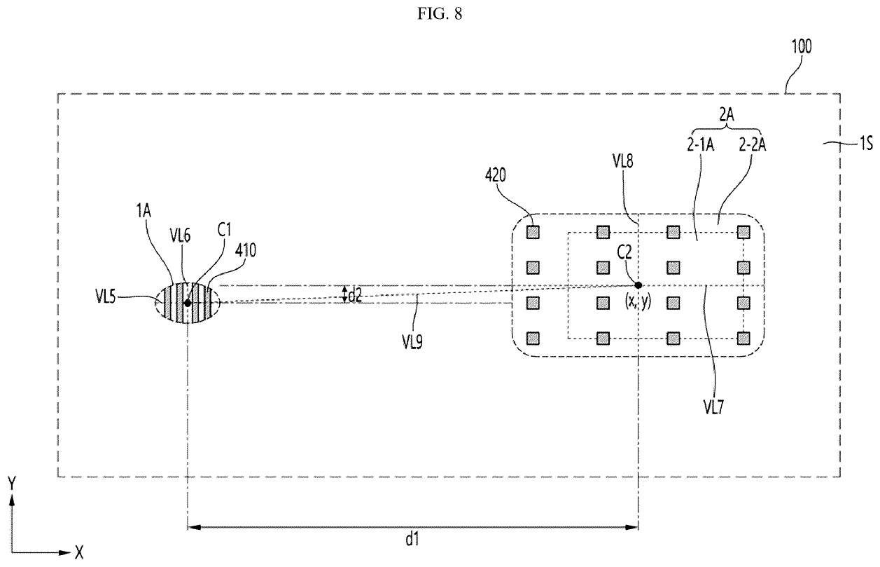

Meanwhile, referring to FIGS. 7 and 8, the first center C1 and the second center C2 may be defined differently.

First, the optical device has defined X-axis and Y-axis.

In addition, a plurality of virtual straight lines passing through the first center C1 and the second center C2 are defined.

For example, a fifth virtual straight line VL5 passing through the first center C1 and parallel to the X-axis is defined. In addition, a sixth virtual straight line VL6 passing through the first center C1 and parallel to the Y-axis is defined. In addition, a seventh virtual straight line VL7 passing through the second center C2 and parallel to the X-axis is defined. In addition, an eighth virtual straight line VL8 passing through the second center C2 and parallel to the Y-axis is defined.

Thus, the first center C1 is defined as a point in which the fifth straight line VL5 and the sixth straight line VL6 intersect. In addition, the second center C2 is defined as a region in which the seventh straight line VL7 and the eighth straight line VL8 intersect.

The coordinates of each of the first center C1 and the second center C2 are set.

In detail, first coordinates of the first center C1 are set to (0, 0). In addition, second coordinates of the second center C2 are set to (x, y).

The x and the y can have set sizes. The x can be 30 mm or more to 45 mm or less. In addition, the y can be −10 mm or more to 5 mm or less. (y≠0)

The x has a positive value. That is, the second center C2 is disposed to the right of the first center C1 in the X-axis direction. The x has a set range. In detail, the x may be 30 mm or more. The x may be 45 mm or less. The x may be 30 mm to 45 mm. Thus, the first center C1 and the second center C2 are spaced apart from each other by a set range in the X-axis direction. In detail, the first center C1 and the second center C2 are spaced apart from each other by 30 mm to 45 mm in the X-axis direction. Therefore, the first center C1 and the second center C2 are spaced apart from each other by the first interval d1. The first interval d1 in the X-axis direction may be 30 mm to 45 mm.

The y has a positive or negative value. That is, the second center C2 is disposed below or above the first center C1 in the Y-axis direction.

Referring to FIG. 7, the second center C2 is disposed below the first center C1 in the Y-axis direction. The y has a set range. In detail, the y may be −10 mm or more. The y may be less than 0. The y may be between −10 mm and less than 0. Thus, the first center C1 and the second center C2 are spaced apart from each other by a set range in the Y-axis direction. In detail, the first center C1 and the second center C2 are spaced apart from each other by −10 mm to less than 0 mm in the Y-axis direction. Therefore, the first center C1 and the second center C2 are spaced apart from each other by a second interval d2. The second interval d2 in the Y-axis direction may be −10 mm to less than 0 mm.

Thus, the second region 2A is disposed below the first region 1A. Therefore, the user can easily see the third light emitted from the second region 2A. Typically, the user who wears AR glasses utilizes the lower portion of the glasses lens more than the upper portion thereof. The light source member 200 may be disposed on the user's temple. That is, when the light source member 200 is disposed on the frame of the AR glasses, the light emitted from the light source member 200 is incident on an upper portion of a glasses lens. The second region from which the light is emitted is disposed below the first region. Therefore, the user can easily see the image information transmitted through the optical device.

Referring to FIG. 8, the second center C2 is disposed above the first center C1 with respect to the Y-axis direction. The y has a set range. In detail, the y can be greater than 0. The y may be 5 mm or less. The y may be greater than 0 to less than or equal to 5 mm. Thus, the first center C1 and the second center C2 are spaced apart from each other by a set range in the Y-axis direction. In detail, the first center C1 and the second center C2 are spaced apart from each other by greater than 0 mm to less than or equal to 5 mm in the Y-axis direction. Therefore, the first center C1 and the second center C2 are spaced apart from each other by the second interval d2. The second interval d2 in the Y-axis direction may be greater than 0 mm to less than or equal to 5 mm.

Thus, the second region 2A is disposed above the first region 1A. Therefore, even when the 2-1 region 2-1A from which light is emitted to the user is disposed so as to be significantly biased in the Y-axis direction to a lower portion of the second region 2A, the user can easily see the image information transmitted through the optical device.

That is, the y is −10 mm to less than 0 or greater than 0 to less than or equal to 5 mm. Thus, the first center C1 and the second center C2 are spaced apart from each other by −10 mm to less than 0 mm or greater than 0 mm to less than or equal to 5 mm in the Y-axis direction.

Therefore, the first center C1 and the second center C2 are spaced apart from each other by a first interval d1 of 30 mm to 45 mm in the X-axis direction, and by a second interval d2 of −10 mm to less than 0 mm or greater than 0 mm to less than or equal to 5 mm in the Y-axis direction.

Additionally, a ninth straight line VL5 that connects the first center C1 and the second center C2 is defined. The ninth straight line VL9 is not parallel to the fifth straight line VL5. Additionally, the ninth straight line VL9 is not parallel to the seventh straight line VL7. That is, the ninth straight line VL9 is not parallel to the X-axis direction.

Therefore, the first center C1 and the second center C2 do not coincide with each other in both the X-axis direction and the Y-axis direction.

The first region 1A and the second region 2A are spaced apart from each other by the first interval d1 in the X-axis direction and the second interval d2 in the Y-axis direction. At this time, the first interval d1 is larger than the second interval d2.

Thus, an incident region and an emission region of the optical device 100 are spaced apart from each other in the X-axis direction. That is, light incident onto the first region 1A is guided in the X-axis direction and is emitted from the second region 2A.

Thus, the user can use the display device with the same feeling as if he or she is wearing actual glasses. That is, the light source member 200 is not disposed on the user's eyes, but is disposed at a location adjacent to the user's temple. Therefore, the user can use the display device as a portable, eyeglass-type display device.

Meanwhile, the pattern of the first diffractive element 410 and the pattern of the second diffractive element 420 can have a set directionality.

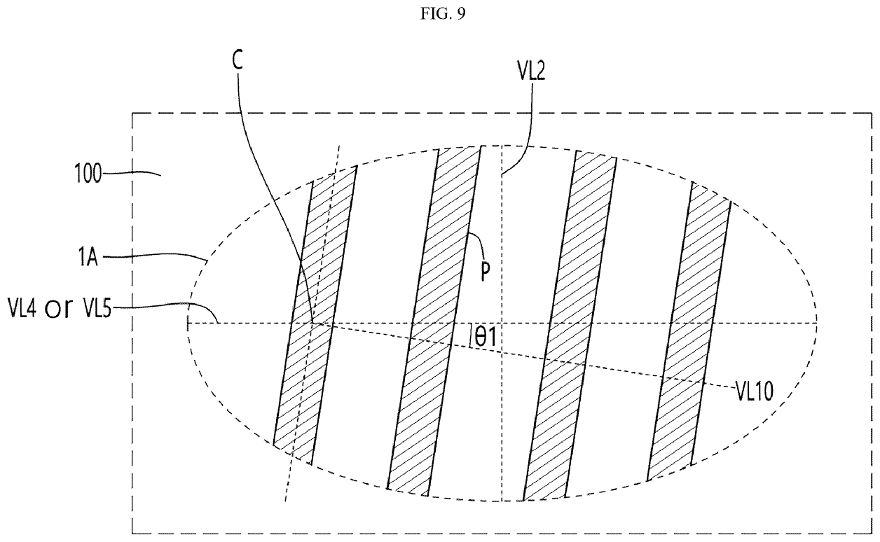

Referring to FIG. 9, in the first pattern P1 of the first diffractive element 410, a tenth straight line VL10 perpendicular to a lengthwise direction of the pattern is defined. In detail, the first pattern P1 is a line pattern. In addition, the tenth straight line VL10 is a line passing through a center C of the line pattern.

The tenth straight line VL10 is not parallel to the fourth straight line VL4. That is, the tenth straight line VL10 is inclined at an acute first angle θ1 with respect to the fourth straight line VL4 or the fifth straight line VL5. That is, a line passing through the center C of the line pattern and the fourth straight line form the acute first angle. The center C of the line pattern can be defined as a region having the same interval as the outermost lines of the line pattern.

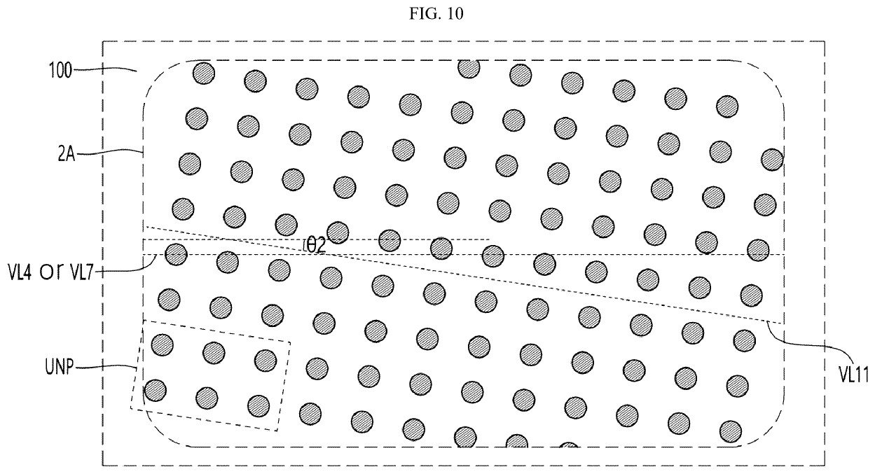

Referring to FIG. 10, in the second diffractive element 420, an eleventh straight line VL11 that extends in the row direction is defined. The eleventh straight line VL11 is not parallel to the fourth straight line VL4. That is, the eleventh straight line VL11 is inclined at an acute second angle θ2 with respect to the fourth straight line VL4 or the seventh straight line VL7.

In detail, the second angle θ2 is related to the first interval d1 and the second interval d2. In detail, the second angle θ2 satisfies the following Equation.

½*arctan(d2/d1)<second angle (θ2)<⅔*arctan(d2/d1) [Equation]

Since the second angle θ2 satisfies the above Equation, the position of the second region 2A is optimized. That is, the 2-1 region 2-1A can be prevented from being greatly biased in one direction with respect to the entire second region 2A. That is, it is possible to prevent the 2-1 region 2-1A from which light is emitted to the user from being greatly biased in the X-axis or Y-axis direction.

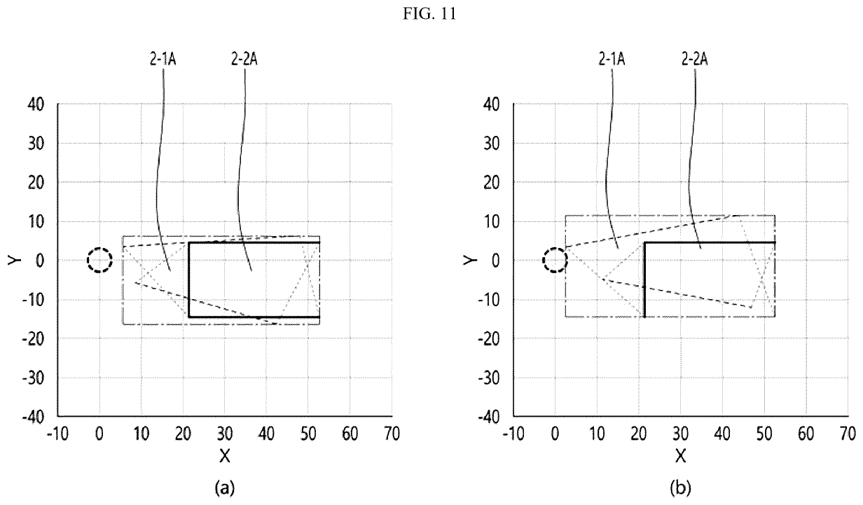

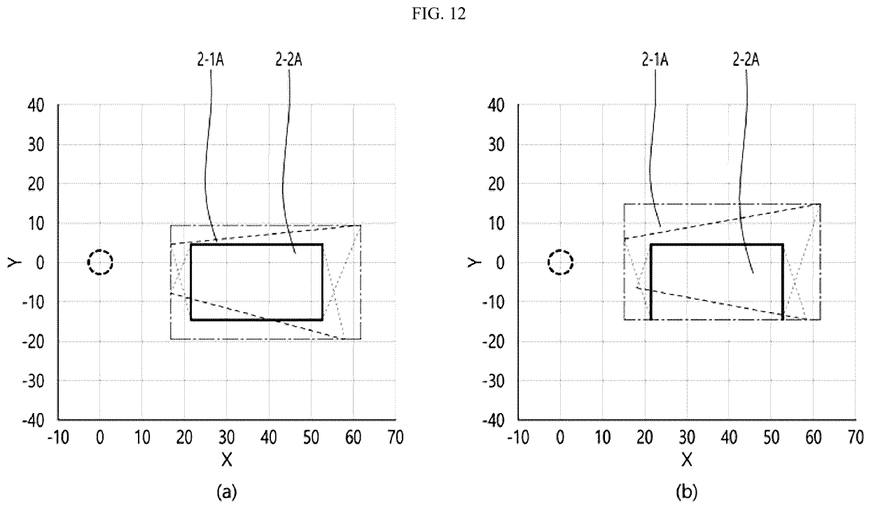

FIGS. 11 and 12 are drawings for describing the effects when the first pattern of the first diffractive element 410 and the second pattern of the second diffractive element 420 have set directionality. FIG. 11 is a drawing when the second light L2 expands to 60° by the second diffractive element 410. FIG. 12 is a drawing when the second light L2 expands to 90° by the second diffractive element 410.

FIGS. 11A and 12A illustrate a case in which the first pattern of the first diffractive element 410 and the second pattern of the second diffractive element 420 have set directionality. FIGS. 9B and 10B illustrate a case in which the first pattern of the first diffractive element 410 and the second pattern of the second diffractive element 420 do not have directionality.

Referring to FIGS. 9 and 10, when the first pattern and the second pattern have set directionality, the 2-2 region 2-2A is not biased to one side within the second region 2A. Thus, an area of the 2-2 region 2-2A in which the user sees the image information increases. Therefore, user's visibility is improved.

On the other hand, when the first pattern and the second pattern do not have set directionality, the 2-2 region 2-2A is very biased to one side within the second region 2A. Thus, the area of the 2-2 region 2-2A in which the user sees the image information is reduced. Therefore, the user's visibility is reduced.

The size of the optical device is reduced according to the embodiment. In detail, the optical device includes a second diffractive element that diffracts light in two directions. Therefore, no additional diffractive element is required to expand the angle of the light.

Since the additional diffractive elements are omitted, the size of the optical device is reduced. In addition, the user's visibility is improved.

The incident region and the emission region of the optical device are spaced apart from each other in the X-axis direction. That is, light incident on the incident region moves in the X-axis direction and is emitted to the emission region.

The light source member that emits light to the optical device is disposed in the region adjacent to the user's temple. Therefore, the user can use the wearable device with a feeling of wearing similar to that of actual glasses.

The centers of the first region, which is the incident region, and the second region, which is the emission region, do not coincide with each other in the X-axis direction and the Y-axis direction.

Thus, the second region is disposed below the first region. Therefore, the user can easily see light including the image information emitted from the light source member.

An optical device according to an embodiment includes a first diffractive element and a second diffractive element. A pattern of the first diffractive element and a pattern of the second diffractive element are inclined with respect to the X-axis direction.

Thus, the diffraction efficiency of the first diffractive element and the second diffractive element is improved. Therefore, a region in which light is emitted toward the user in the second region can be formed at an optimal position. Therefore, the user's visibility is improved.

Meanwhile, the first pattern P1 and the second pattern P2 may have a period. The period of the pattern is defined as a distance at which the first pattern P1 and the second pattern P2 are repeated.

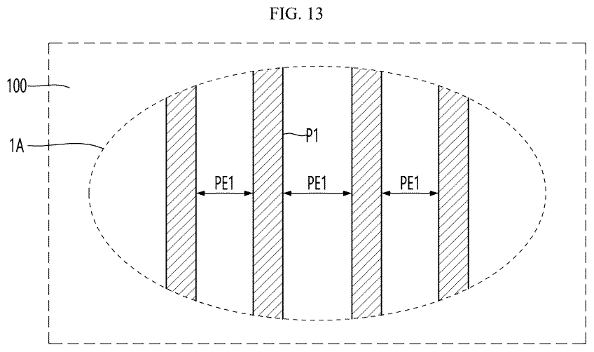

Referring to FIG. 13, the first pattern P1 may have a set first period PE1. The first period PE1 is a distance between the first patterns P1. In detail, the first patterns P1 are spaced apart from each other by a distance of the first period PE1. The first patterns P1 are spaced apart from each other in the direction perpendicular to a lengthwise direction of the first pattern P1.

The first period PE1 satisfies at least one of the following Equations 1 to 4.

$$λ / 1.75 < first period < λ / 1.37 \qquad [ Equation 1 ]$$

(In Equation 1, λ is a wavelength of light (nm).)

$$λ / 1.75 < first period < λ / 1.37 \qquad [ Equation 2 ]$$

(In Equation 2, λ satisfies 450 nm≤λ≤490 nm.)

$$λ / 1.75 < first period < λ / 1.37 \qquad [ Equation 3 ]$$

(In Equation 3, λ satisfies 490 nm<λ≤570 nm.)

$$λ / 1.75 < first period < λ / 1.37 \qquad [ Equation 4 ]$$

(In Equation 4, A satisfies 620 nm≤λ≤780 nm.)

The first period PE1 may vary according to a wavelength of light emitted from the light source member 200, as in Equation 1. For example, the first period PE1 may be proportional to the wavelength of the light.

The Equation 2 is for a case in which blue light is emitted from the light source member 200. The Equation 3 is for a case in which green light is emitted from the light source member 200. The Equation 4 is for a case in which red light is emitted from the light source member 200.

Referring to the Equations 1 to 4, the first period PE1 in the case in which red light is emitted from the light source member 200 may be greater than the first period PE1 in the case in which green light and blue light are emitted from the light source member 200. Additionally, the first period PE1 in which green light is emitted from the light source member 200 may be greater than the first period PE1 in which blue light is emitted from the light source member 200.

Since the first period PE1 satisfies at least one of Equations 1 to 4, the diffraction efficiency of incident light incident on the optical device 100 is improved. That is, the diffraction efficiency of light diffracted by the first diffractive element 410 can be improved. Therefore, light lost to the outside of the optical device 100 is reduced. In addition, the internal total reflection efficiency of the optical device 100 is improved.

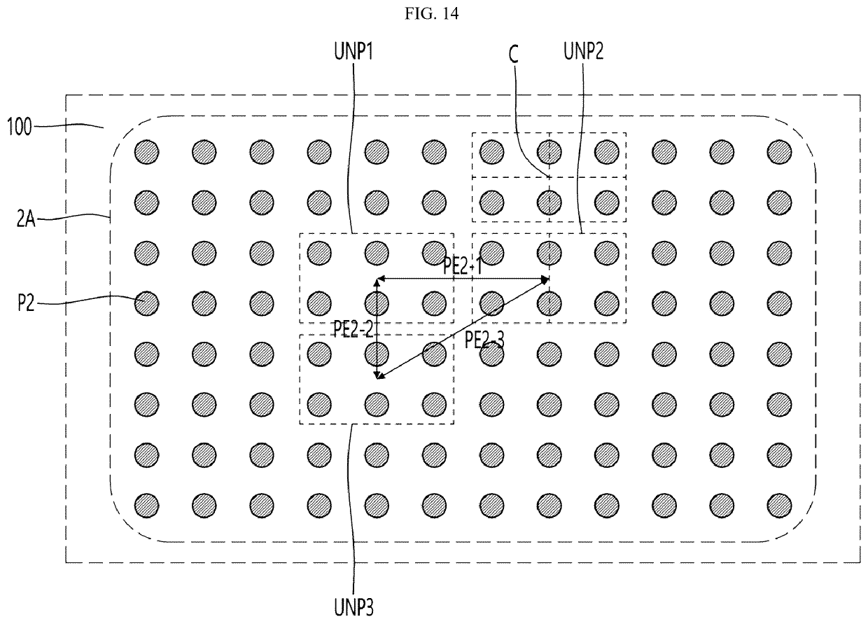

Referring to FIG. 14, the second pattern P2 has a set second period. The second period is a distance between the unit patterns of the second diffractive element 420. In detail, the second period is a distance between the centers of the unit patterns.

The unit patterns are spaced apart from each other by a distance of the second period. For example, the unit pattern may include a first unit pattern UNP1, a second unit pattern UNP2, and a third unit pattern UNP3.

The first unit pattern UNP1 and the second unit pattern UNP2 face each other in the row direction. In addition, the first unit pattern UNP1 and the third unit pattern UNP3 face each other in the column direction. Additionally, the second unit pattern UNP2 and the third unit pattern UNP3 face each other in a direction between the row direction and the column direction.

Thus, each of the first unit pattern UNP1, the second unit pattern UNP2, and the third unit pattern UNP3 has a period according to the direction.

The second period may include the 2-1 period PE2-1 of the first unit pattern UNP1 and the second unit pattern UNP2, the 2-2 period PE2-2 of the first unit pattern UNP1 and the third unit pattern UNP3 and the 2-3 period PE2-3 of the second unit pattern UNP2 and the third unit pattern UNP3.

The 2-1 period PE2-1 is a period in the row direction. The 2-2 period PE2-2 is a period in the column direction. The 2-3 period PE2-3 is a period between the row direction and the column direction. That is, the 2-3 period PE2-3 is a period of unit patterns facing each other in the diagonal direction.

The 2-1 period PE2-1, the 2-2 period PE2-2, and the 2-3 period PE2-3 can satisfy at least one of the following Equations 5 to 7.

$$0.9 < 2 - 1 period / first period < 1.1 , and \qquad [ Equation 5 ]$$

$$0.9 < 2 - 2 period / first period < 1.1$$

$$0.9 < 2 - 1 period / first period < 1.1 , \qquad [ Equation 6 ]$$

$$0.9 < 2 - 2 period / first period < 1.1 , and$$

$$0.9 < 2 - 3 period / first period < 1.1$$

$$1.8 < 2 - 1 period / first period < 2.2 \qquad [ Equation 7 ]$$

$$1.8 * \sqrt{3} < 2 - 2 period / first period < 2.2 * \sqrt{3}$$

The second period varies according to an extent to which the second light L2 expands by the second diffraction pattern.

When the second light L2 expands to 90° by the second diffractive element 420, the second period can satisfy Equation 5 or 6. That is, the 2-1 period PE2-1 and the 2-2 period PE2-2 may be the same. Alternatively, the 2-1 period PE2-1, the 2-2 period PE2-2 and the 2-3 period PE2-3 may be the same.

Alternatively, when the second light L2 expands to 60° by the second diffractive element 420, the second period PE2 may satisfy Equation 7. That is, the 2-1 period PE2-1 and the 2-2 period PE2-2 may be different.

In addition, the second period may vary according to a wavelength of light emitted from the light source member 200. That is, the second period is inversely proportional to the first period. Therefore, the second period may be inversely proportional to the wavelength of the light.

Therefore, the second period in which blue light is emitted from the light source member 200 may be greater than the second period in which green light and blue light are emitted from the light source member 200. Additionally, the second period when green light is emitted from the light source member 200 may be greater than the second period when red light is emitted from the light source member 200.

Since the second period satisfies at least one of Equations 5 and 6, the diffraction efficiency of the light emitted from the optical device 100 is improved. That is, the diffraction efficiency of the light diffracted by the second diffractive element 420 is improved. Therefore, the diffraction efficiency of the light emitted outside the optical device 100 is improved. Therefore, the user can receive the image information with improved brightness.

The optical device may be reduced in size according to the embodiment.

In detail, since the optical device includes the second diffractive element that diffracts light in two directions, no additional diffractive element is required to expand the angle of the light.

Therefore, since additional diffractive elements are omitted, the size of the optical device can be reduced, and the user's visibility can be improved.

In the optical device according to the embodiment, the incident region and the emission region of the optical device are spaced apart from each other in the X-axis direction. That is, light incident on the incident region of the optical device moves in the X-axis direction and is emitted to the emission region.

That is, since the light source element that emits light to the optical device is disposed in a region adjacent to the user's temple, the user can use the wearable device with a feeling of wearing similar to that of actual glasses.

In the optical device according to the embodiment, the centers of the first region, which is the incident region, and the second region, which is the emission region, do not coincide with each other in the X-axis direction and the Y-axis direction.

Thus, the second region can be disposed below the first region. Therefore, the user can easily see light including image information emitted from the light source member.

In the optical device according to the embodiment, the pattern of each of the first diffractive element and the second diffractive element has a period within a set range.

Thus, since the diffraction efficiency of the first diffractive element and the second diffractive element is improved, the region in which light is emitted toward the user in the second region can be formed at an optimal position, and since the light including image information can have improved brightness, the user's visibility can be improved.

Additionally, the patterns of the first diffractive element and the second diffractive element have a period within a set range.

Thus, the diffraction efficiency of the first diffractive element and the second diffractive element is improved. Therefore, the region in which light is emitted toward the user in the second region can be formed at an optimal position. Additionally, the light including the image information has improved brightness. Therefore, the user's visibility is improved.

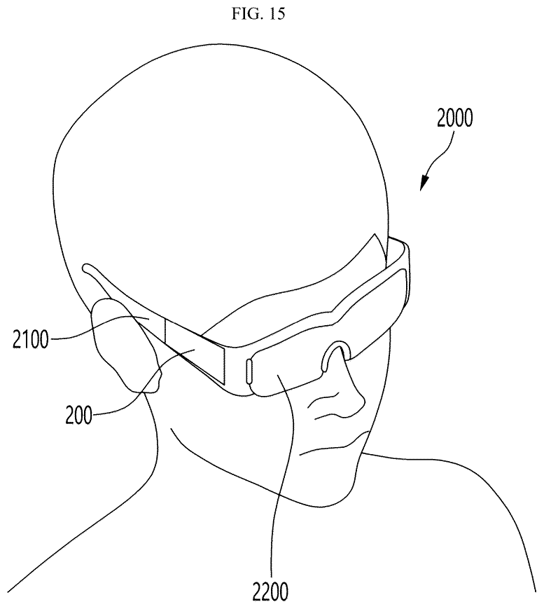

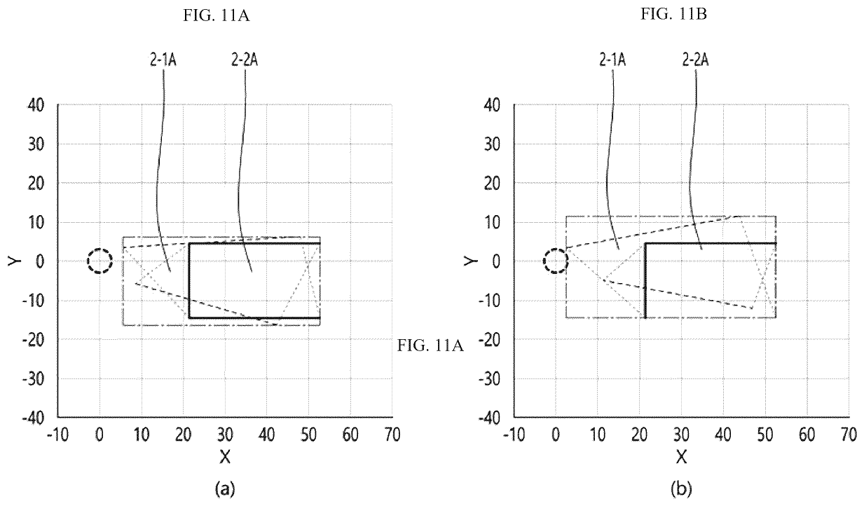

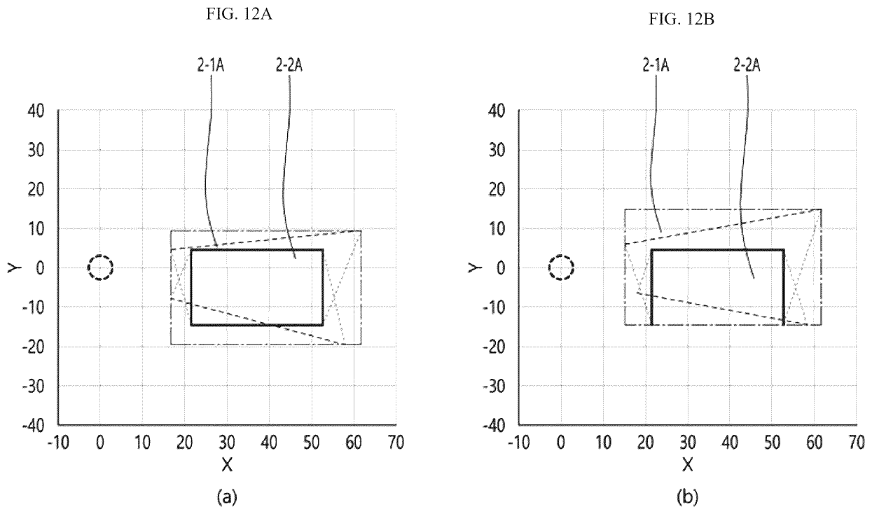

Hereinafter, with reference to FIG. 15, an example of the display device including the optical device according to the embodiment will be described.

Referring to FIG. 15, the optical device can be applied to a wearable display device. In detail, the optical device can be applied to a wearable display device worn on the head or ear of a human body.

For example, a display device 2000 may be an augmented reality device.

The display device 2000 includes a wearing unit 2100 and a display unit 2200.

The wearing unit 2100 extends in one direction. The wearing unit 2100 is worn on the user's body. For example, the wearing unit 2100 is worn on the user's head or ear. Thus, the display device 2000 is fixed to the user's body. For example, the wearing part 2100 may be a glasses frame of the wearable display device.

The light source member 200 is disposed on the wearing unit 2100. The light source member 200 emits light in the direction to the display unit 2200. In detail, the light source member 200 emits light including image information in the direction to the display unit 2200. In detail, the light source member 200 may be a projector.

The display unit 2200 may be the optical device described above. Alternatively, the display unit 2200 may be AR glasses including the optical device.

Thus, the user can receive light including image information emitted from the light source member 200 through the display unit 2200. Therefore, the user can see virtual reality and augmented reality of real reality through the optical device.

The features, structures, effects, and the like described in the above-described embodiments are included in at least one embodiment of the present invention, and are not necessarily limited to only one embodiment. Furthermore, the features, structures, effects, and the like exemplified in each embodiment can be combined or modified and implemented in other embodiments by a person having ordinary knowledge in the field to which the embodiments belong. Therefore, the contents related to such combinations and modifications should be interpreted as being included within the scope of the present invention.

In addition, although the above has been described focusing on the embodiments, they are merely examples and do not limit the present invention, and those with ordinary knowledge in the field to which the present invention belongs will recognize that various modifications and applications not illustrated above are possible without departing from the essential characteristics of the embodiments. For example, each component specifically shown in the embodiments can be modified and implemented. Additionally, the differences related to such modifications and applications should be interpreted as being included in the scope of the present invention defined in the appended claims.

1. An optical device comprising:
a first region configured to guide incident light; and
a second region configured to emit the light guided from the first region,
wherein the first region includes a first pattern,
the second region includes a second pattern which differs in size or shape from the first pattern,
a first virtual straight line which passes through a first center of the first region is defined,
a second virtual straight line which passes through a second center of the second region and is parallel to the first straight line is defined,
a third straight line which connects the first center and the second center is defined,
a fourth straight line which connects the first straight line and the second straight line is defined,
the third straight line is perpendicular to the first straight line and the second straight line,
the third straight line is longer than the fourth straight line, and
when a line perpendicular to the first straight line at the first center is defined as an X-axis, and the first straight line is defined as a Y-axis,
coordinates of the first center of the first region are (0, 0),
coordinates of the second center of the second region are (x, y),
the x is 30 mm or more and 45 mm or less,
the y is −10 mm or more and 5 mm or less, and
the y is not 0.

2. The optical device of claim 1, wherein the first pattern includes a line pattern, and
a line which passes through a center of the line pattern and the fourth straight line form an acute first angle.

3. The optical device of claim 1, wherein the second pattern includes at least two patterns having different shapes.

4. The optical device of claim 1, wherein the first pattern diffracts the light in one direction, and
the second pattern diffracts the light in two directions.

5. The optical device of claim 1, wherein the second region includes a 2-1 region disposed inside the second region and a 2-2 region disposed at an edge of the second region, and
light is emitted toward a user through the 2-1 region.

6. An optical device comprising:
a first region configured to guide incident light; and
a second region configured to emit the light guided from the first region,
wherein the first region includes a first pattern,
the second region includes a second pattern which differs in size or shape from the first pattern,
a first virtual straight line which passes through a first center of the first region is defined,
a second virtual straight line which passes through a second center of the second region and is parallel to the first straight line is defined,
a third straight line which connects the first center and the second center is defined,
a fourth straight line which connects the first straight line and the second straight line with a shortest distance is defined,
the third straight line is longer than the fourth straight line,
the second region includes the second pattern configured of rows and columns of N*M, and
the fourth straight line and N rows form an acute second angle.

7. The optical device of claim 6, wherein in the rows and columns of N+M, an interval between centers of the patterns disposed in one of the N rows and an interval between centers of the patterns disposed in another of the N rows are the same.

8. The optical device of claim 6, wherein the first pattern includes a line pattern, and
the line pattern and the fourth straight line form an acute first angle.

9. The optical device of claim 6, wherein the second pattern includes at least two patterns having different shapes.

10. The optical device of claim 6, wherein the second pattern includes a plurality of unit patterns configured of n rows (n is a natural number) and m columns (m is a natural number).
